(19) United States
(12) Patent Application Publication
(10) Pub. No.: US 2025/0206222 A1
(43) Pub. Date: Jun. 26, 2025

(54) RECREATIONAL VEHICLE AND VARIABLE WATER TANK

(71) Applicant: Thor Tech, Inc., Elkhart, IN (US)

(72) Inventor: Steve Poetschke, Stolpen (DE)

(73) Assignee: Thor Tech, Inc., Elkhart, IN (US)

(21) Appl. No.: 18/987,632

(22) Filed: Dec. 19, 2024

(30) Foreign Application Priority Data
Dec. 22, 2023 (DE) 102023136680.7

(51) Int. Cl. B60P 3/36; B60R 15/00

(52) U.S. Cl. CPC B60P 3/36; B60R 15/00

(57) ABSTRACT

The invention relates to a variable water tank for a recreational vehicle, in particular a motorhome or a caravan, comprising a first compartment and at least one second compartment, wherein the first compartment has a variable volume for holding water, wherein the second compartment has a variable volume for holding water and wherein the first compartment and the second compartment are separated from one another in such a way that a direct exchange of water between the first compartment and the second compartment is prevented. It is proposed that the first compartment is at least substantially formed by a first flexible water canister, that the second compartment is at least substantially formed by a second flexible water canister, and that a peripheral edge of the first water canister and a peripheral edge of the second water canister are connected to one another.

The invention relates to a recreational vehicle, in particular a motorhome or a caravan, and to a variable water tank with a divided volume.

A water tank for motorhomes is known from DE 87 16 514 U1. The known water tank has a container with a connection for fresh water and a connection for used water arranged at a distance therefrom. The container is divided into two compartments by a membrane running in a central plane between the connections and whose area can be changed. In an expedient embodiment, the membrane runs horizontally, wherein the fresh water compartment is arranged at the bottom of the tank and the used water compartment is arranged at the top of the tank. The old water then presses on the membrane with its weight and accelerates the outflow of the fresh water. Two bags can also be arranged in the container of the water tank.

The water tank for motorhomes known from DE 87 16 514 U1 has the disadvantage that its production is complex and therefore expensive. In particular, a stable container is required which must be suitably designed and in which, when designed with the membrane, the membrane must be reliably fastened inside to ensure that the two compartments are sealed. If the membrane is damaged, the fresh water will become unusable due to the old water penetrating it. Repairing or replacing the entire water tank would then be very costly. Furthermore, basic cleaning, which is necessary, for example, after a long period of non-use, is time-consuming because the two compartments can only be filled alternately.

The object of the invention is to provide a variable water tank with a divided volume and a recreational vehicle which have an improved design and/or functionality. In particular, it is an object of the invention to provide a variable water tank and a recreational vehicle, wherein a cost-effective design of at least the components coming into contact with water is possible.

Furthermore, to ensure the purity of the stored fresh water, it may be possible to replace at least one component which comes into contact with the fresh water at low cost.

The object is achieved by a variable water tank having the features of claim 1 and by a recreational vehicle having the features of claim 11. Advantageous further developments of the invention are given in the sub-claims.

The object is achieved by a variable water tank for a recreational vehicle, in particular a motorhome or a caravan, comprising a first compartment and at least one second compartment, wherein the first compartment has a variable volume for holding water, wherein the second compartment has a variable volume for holding water, wherein the first compartment and the second compartment are separated from one another in such a way that a direct exchange of water between the first compartment and the second compartment is prevented, wherein the first compartment is formed at least substantially by a first flexible water canister, wherein the second compartment is formed at least substantially by a second flexible water canister and wherein a peripheral edge of the first water canister and a peripheral edge of the second water canister are connected to one another.

The object is also achieved by a recreational vehicle, in particular a motorhome or a caravan, comprising at least one such variable water tank.

It is advantageous that the first flexible water canister has an outer half-shell, that the second flexible water canister has an outer half-shell, that the peripheral edge of the first water canister is designed as the edge of the outer half-shell of the first flexible water canister and that the peripheral edge of the second water canister is designed as the edge of the outer half-shell of the second flexible water canister. This makes it easy to manufacture the water tank. In particular, the two water canisters can be connected to each other at the edge, which can be done in an integrally bonded manner.

It is advantageous that the first flexible water canister has an inner half-shell, that the second flexible water canister has an inner half-shell, that the peripheral edge of the first water canister is designed as the edge of the inner half-shell of the first flexible water canister and that the peripheral edge of the second water canister is designed as the edge of the inner half-shell of the second flexible water canister. This achieves an advantageous separation of the two compartments from each other. In particular, even if one of the two inner half-shells is damaged, a reliable separation is still ensured, which, for example, prevents contamination of fresh water in one compartment by the service water (waste water) in the other compartment.

It is advantageous that the inner half-shell of the first flexible water canister is designed such that, on the one hand, it rests at least substantially against an inner side of an outer half-shell of the first flexible water canister when the variable volume of the second compartment is filled to the maximum, and, on the other hand, the inner half-shell of the second flexible water canister rests at least substantially against an outer half-shell of the second flexible water canister when the variable volume of the first compartment is filled to the maximum. This makes optimized use possible. In one possible application, fresh water can be taken from one compartment and at least partially returned to the other compartment as service water. As the other compartment gradually fills with the service water, the removal of fresh water is supported due to the resulting displacement effect. If the compartment into which the service water is fed is arranged above the compartment with the fresh water, then the service water can weigh on the fresh water, so that the removal of the fresh water is supported.

It is advantageous that the inner half-shell of the second flexible water canister is designed such that, on the one hand, it rests at least substantially against an inner side of an outer half-shell of the second flexible water canister when the variable volume of the first compartment is filled to the maximum, and, on the other hand, the inner half-shell of the first flexible water canister rests at least substantially against an outer half-shell of the first flexible water canister when the variable volume of the first compartment is filled to the maximum. This results in corresponding advantages.

It is advantageous that the first flexible water canister is at least partially designed symmetrically such that an inner half-shell of the first flexible water canister can be folded into an outer half-shell of the first flexible water canister such that the inner half-shell of the first flexible water canister rests at least substantially against an inner side of the outer half-shell of the first flexible water canister. This allows for optimal space utilization. The displacement effect which occurs, for example, when one compartment is filled with service water relative to the other compartment can be optimized.

It is advantageous that the second flexible water canister is at least partially designed symmetrically such that an inner half-shell of the second flexible water canister can be folded into an outer half-shell of the second flexible water canister such that the inner half-shell of the second flexible water canister rests at least substantially against an inner side of the outer half-shell of the second flexible water canister. This results in corresponding advantages.

It is advantageous that the first water canister and the second water canister are at least substantially identical in shape. In particular, this allows optimized functionality with regard to the outer half-shell of each water canister and the inner half-shell of the other water canister.

It is advantageous that the first water canister has a cuboid-shaped, in particular cubic, main body which at least substantially comprises an outer half-shell of the first water canister and an inner half-shell of the first water canister, and/or that the second water canister has a cuboid-shaped, in particular cubic, main body which at least substantially comprises an outer half-shell of the second water canister and an inner half-shell of the second water canister. This allows an inner half-shell of a water canister to advantageously fit into the outer half-shell of the same water canister on the one hand and into the outer half-shell of the other water canister on the other hand. An advantageous functionality can be achieved by folding.

It is advantageous that the peripheral edge lies at least approximately in a plane in which at least approximately at least one diagonal of the main body of the first water canister and/or at least approximately at least one diagonal of the main body of the second water canister lies. In particular, this allows for optimized folding.

It is advantageous that at least one spacer is provided for the first compartment, which ensures that water can be removed from the variable volume of the first compartment. In one embodiment, the spacer can be arranged at a hose end which is used to remove water. The spacer can have at least lateral openings.

It is advantageous that at least one spacer is provided for the second compartment, which ensures that water can be removed from the variable volume of the second compartment. This allows corresponding advantages to be realized.

It is advantageous that at least one removal hose is provided for the first compartment, via which water can be removed from the variable volume of the first compartment. This allows for reliable removal, in particular at the lowest point.

It is advantageous that at least one removal hose is provided for the second compartment, via which water can be removed from the variable volume of the second compartment. This allows corresponding advantages to be realized.

It is advantageous that the first water canister has an outer half-shell with at least one fixed wall on which a device for level measurement is provided, which allows measurement of the variable volume of the first compartment, and/or that the second water canister has an outer half-shell with at least one fixed wall on which a device for level measurement is provided, which allows measurement of the variable volume of the second compartment. A scale can be implemented which can be read by a user. In an advantageous further development, an electronic design can be realized.

Depending on the design and optionally advantageous further development, one or more of the following features and advantages can be realized or made possible. In particular, advantageous features and corresponding advantages over conventional designs can be realized. In particular, a variable water tank with a divided volume for fresh and waste water can be realized by forced expansion of the containers and optional level measurement.

In a conventional design, flexible tank systems can consist of a plurality of layers of plastics films welded together, which are optionally provided with an outer covering made of neoprene or other textile. Such conventional designs with a divided volume for fresh and waste water can consist of two of these film bags (with or without a jacket) or of a solid outer tank and a second flexible tank inside made of elastic material with a film and a textile, which can expand when filled and contract when emptied.

Due to the way they are manufactured, these conventional tank systems take on a pillow shape when fully filled, which is bulging in the middle and narrow on the sides. When two cushion shapes are arranged one above the other, a defined position relative to each other cannot be ensured, so that a frame, such as a housing, basket, net or strap, is required to hold the tanks in place. The expansion of the tanks with such cushion shapes cannot be influenced, since a flat support on top of each other or next to each other is only possible in the middle bulbous region. A level measurement cannot be carried out in such tank systems or can only be carried out indirectly and with great effort by means of flow measurement, since the shape is undefined at every point.

In particular, two flexible drinking water canisters can be used, which are connected to each other in a watertight manner by two half-shells each on a predetermined separation plane, which can preferably run diagonally or horizontally. These containers, which are preferably separated diagonally, can be stacked inside each other with the separation planes in contact with each other.

For example, one of the two containers assumes its maximum cubic shape, which corresponds to the filled state, and the other unfilled container is advantageously folded diagonally so that it can be placed over one half of the filled container. This arrangement can then be fixed as required by a housing, a space limiter or belts to prevent drifting apart. In particular, the two water canisters can be connected in this way. An integrally bonded connection at the edge is also possible.

The system can be separated by additional equipment such as an aqua stop and/or a ball valve. Especially in the case of a smaller design, in particular up to a total volume of approximately 20 l, the water tank can also be designed to be removable. This prevents leakage during removal because lifting increases the lateral pressure and forces the water into the pipes.

A removable water tank has the particular advantage that maintenance is easy due to low cost. For example, after a long period of downtime, before the recreational vehicle is sold as a used vehicle, in the case of a rental vehicle after one use or at least after one season, when the fresh water tank is found to be dirty or in similar cases, the variable water tank can simply be replaced with a new water tank. As part of the replacement, the fresh water pipes can be easily flushed.

Any approximately cubic container which can accommodate both water canisters can serve as a housing, which is optional and not absolutely necessary. For example, a Eurobox, a conventional fresh water tank or a conventional waste water tank can serve as the housing. The system can be designed so that up to approximately 20 l of water, in particular fresh water, can be removed. This means that the system is neither too heavy nor too impractical for normal users.

One possible design would be for the water tank to be permanently installed in the recreational vehicle by the manufacturer. This can be done in a desired design, in particular size, wherein individual adaptation to customer requirements is easily possible. In the case of permanent installation, at least one filler neck can be used for filling with fresh water, for example.

The design realized for the water tank with an arrangement of two water canisters can be realized in particular in such a way that it is inherently stable. This means that the water tank can be placed freely on the floor without tipping over.

By having two complete fixed walls per container, one oriented horizontally and one vertically, it is possible to advantageously allow electrical level measurement or analog level measurement by means of a simple scale on the vertical wall of the water canister.

For water removal by means of a pump, which is preferably self-priming, no forced ventilation is required to compensate for the volume removed, since the tanks are preferably flexible. A lack of ventilation in the fresh water tank can further enhance the effect.

If the water canisters for fresh water are arranged at the bottom and those for waste water at the top, a waste water pump can be dispensed with if the elevation difference is sufficient because gravity draws the waste water into the waste water container at the top and the fresh water does not exert any pressure on the waste water container.

Because the waste water tank can exert considerable pressure on the fresh water tank once it reaches a certain filling level, any possible cutting off of the fresh water removal point must be prevented if necessary. This can be achieved by using a spacer which is open at the side and designed in a suitable shape.

Depending on the desired volume and the available installation space, different width variants can be realized. For example, their horizontal and vertical surfaces can be changed in the same ratio to allow for the required folding. Special variants can also have asymmetrical side lengths, which can, however, affect foldability. Preferably, a design is realized in which reliable folding from one water canister into the other and vice versa is ensured.

A horizontal separation of the container halves is possible in one conceivable design. However, a diagonal separation is preferred. The diagonal separation is particularly advantageous with regard to inherent stability and level measurement in any orientation of the containers.

Fresh water can also be removed from the upper part of the container if a corresponding removal point is formed and there is a hose inside that reaches the lowest point. An end piece with side openings also advantageously prevents it from sticking to the container wall. However, variations are also possible.

The arrangement of the two tanks can also be swapped so that the fresh water tank is on top. Then, constructive measures such as sewage pumps or other aids can ensure that the tank located below is filled, for which a certain pressure is applied.

Both tanks can also be fitted with drainage devices in the lower region, which is particularly advantageous when installed permanently.

Further advantages and details of the invention are explained in more detail with reference to the exemplary embodiments shown in the schematic figures. In the figures:

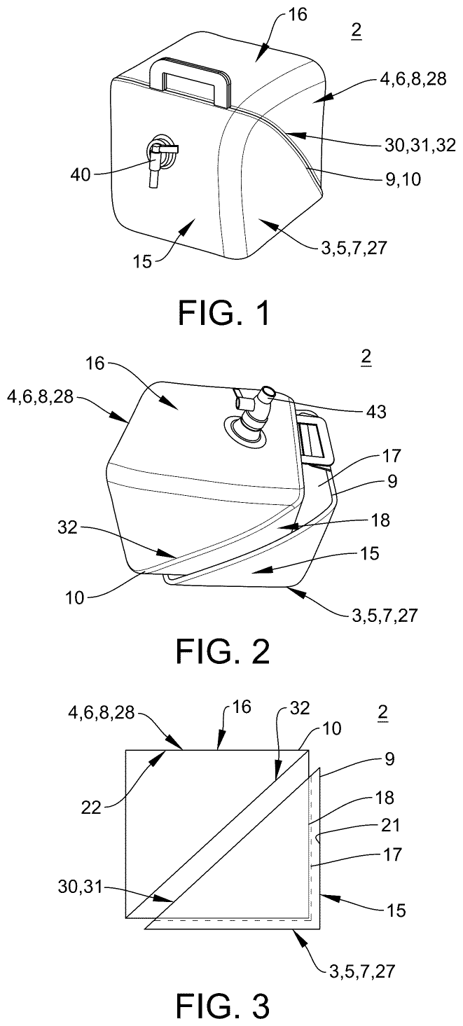

FIG. 1 shows a variable water tank for a recreational vehicle in a schematic, spatial representation according to an exemplary embodiment, wherein a view is shown obliquely from above;

FIG. 2 is a spatial, partially exploded view of the variable water tank shown in FIG. 1, wherein two water canisters are shown separately to explain the design and functioning;

FIG. 3 shows the water tank shown in FIG. 2 according to the partial exploded view in a schematic sectional view for further explanation of the design and functioning, wherein inner half-shells of the water canisters are folded into the lower outer half-shell;

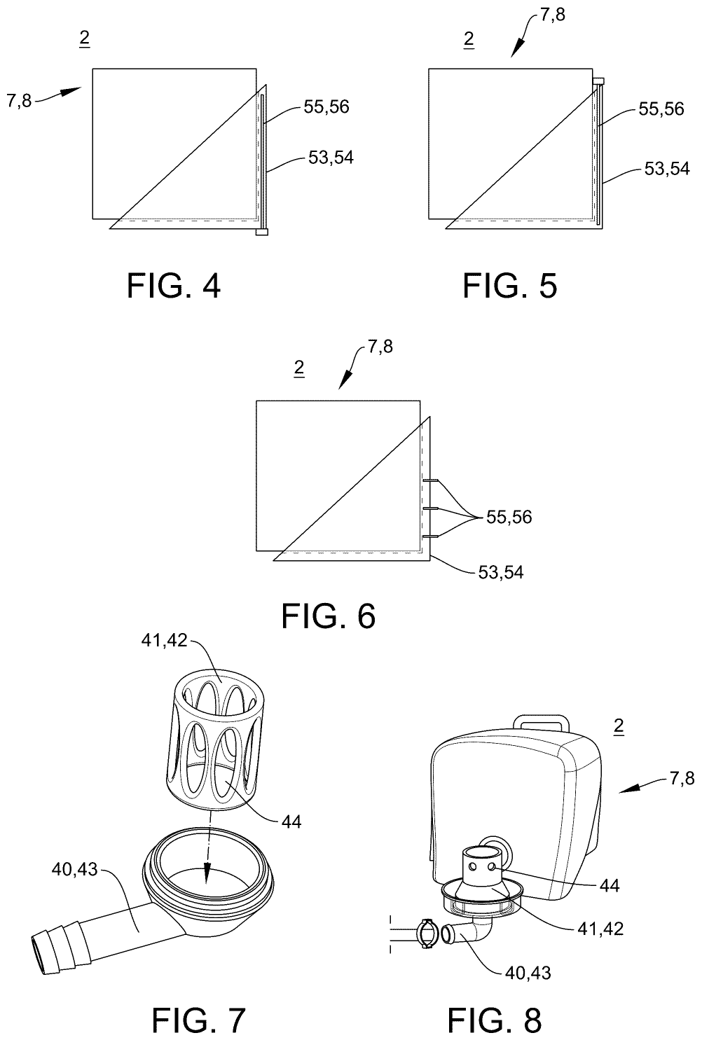

FIG. 4 shows the sectional view shown in FIG. 3 according to a modified embodiment in which a level probe is provided for measuring the level on the lower water canister;

FIG. 5 shows the sectional view shown in FIG. 3 according to a modified embodiment in which a level probe is provided for measuring the level on the upper water canister;

FIG. 6 shows the sectional view shown in FIG. 3 according to a modified embodiment in which a level scale is provided for level measurement;

FIG. 7 shows a water removal point with a spacer in a spatial representation according to an advantageous further development of a variable water tank;

FIG. 8 shows a water tank with a water removal point and a spacer in a schematic, spatial representation to explain a modified embodiment;

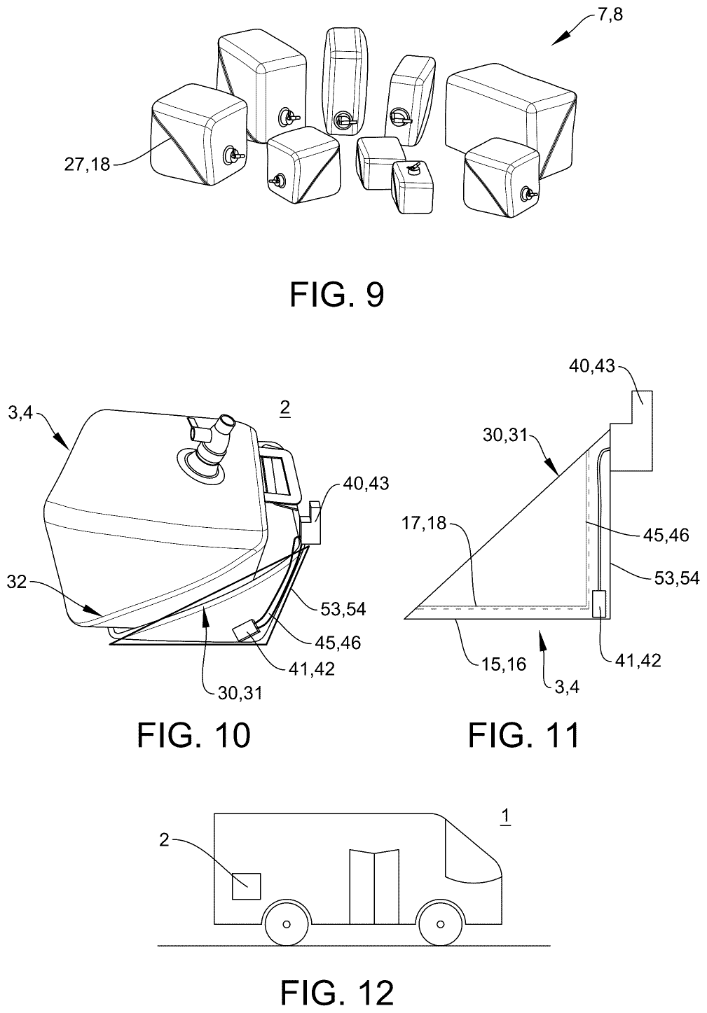

FIG. 9 shows different design variants for a water canister, wherein in particular two identically shaped water canisters are used in a variable water tank;

FIG. 10 shows a variable water tank in a spatial, partially exploded view, which is particularly suitable for an upper arrangement of the fresh water;

FIG. 11 shows the variable water tank shown in FIG. 10 in a schematic sectional view, wherein the lower water canister can be filled with pressure;

FIG. 12 shows a recreational vehicle with a variable water tank in a highly simplified, schematic representation.

FIG. 1 shows a variable water tank 2 used for a recreational vehicle 1 (FIG. 12) in a schematic, spatial representation according to an exemplary embodiment. FIG. 1 shows a view obliquely from above of the water tank 2 in a state in which it can be used in the recreational vehicle 1. In this regard, FIG. 2 shows a spatial, partially exploded view of the variable water tank 2 shown in FIG. 1, wherein the elements of the water tank 2 are shown partially separated in order to explain the design and functioning. The recreational vehicle 1 is preferably designed as a motorhome or caravan. The variable water tank 2 is particularly suitable for such applications.

The variable water tank 2 comprises a first compartment 3 and a second compartment 4. The first compartment 3 has a variable volume 5 for holding water. The second compartment 4 also has a variable volume 6 for holding water. For example, the first compartment 3 can be arranged below the second compartment 4. In a preferred embodiment, the lower compartment, i.e., in this example the first compartment 3, is initially filled with fresh water, while the upper compartment, i.e., in this example the second compartment 4, is gradually filled with service water depending on the consumption of fresh water from the first compartment 3. The first compartment 3 and the second compartment 4 are separated from each other. This means that no direct exchange of water between the first compartment 3 and the second compartment 4 is possible.

The first compartment 3 is formed by a first flexible water canister 7. The second compartment 4 is formed by a second flexible water canister 8. A peripheral edge 9 of the first water canister 7 and a peripheral edge 10 of the second water canister 8 are connected to each other. This can be achieved by means of an integrally bonded connection. In a modified embodiment, the water canisters 7, 8 can also be positioned so firmly relative to one another that the two peripheral edges 9, 10 at least approximately abut one another. This can be achieved by connecting means, such as tensioning straps, or by a common housing or in other ways.

The first flexible water canister 7 comprises an outer half-shell 15. The second flexible water canister 8 comprises an outer half-shell 16. The peripheral edge 9 of the first water canister 7 is designed as the edge 9 of the outer half-shell 15. Furthermore, the peripheral edge 10 of the second water canister 8 is designed as the edge 10 of the outer half-shell 16. In addition, the first flexible water canister 7 comprises an inner half-shell 17. The second flexible water canister 8 comprises an inner half-shell 18. The first water canister 7 can be at least substantially formed by the half-shells 15, 17. The second water canister 7 can be at least substantially formed by the half-shells 16, 18. The peripheral edge 9 of the first water canister 7 is thereby simultaneously designed as the edge 9 of the inner half-shell 17 of the first flexible water canister 7. Furthermore, the peripheral edge 10 of the second water canister 8 is thereby simultaneously designed as the edge 10 of the inner half-shell 18 of the second flexible water canister 8.

FIG. 3 shows the water tank 2 shown in FIG. 2 according to the partial exploded view in a schematic sectional view for further explanation of the design and functioning of the exemplary embodiment, wherein in this view the inner half-shells 17, 18 of the water canisters 7, 8 are folded into the lower outer half-shell 15 of the first water canister 7. This corresponds to the situation also shown in FIG. 2, in which, according to the preferred application, the fresh water stored in the lower first compartment 3 is at least largely removed and the upper second compartment 4 is at least largely filled.

In a corresponding manner, the reverse situation arises in which the first compartment 3 is at least largely filled with fresh water, while no service water has (yet) been fed into the second compartment 4, so that the variable volume 6 is minimal and preferably disappears, since the volume 5 of the first compartment is maximal and preferably completely occupies the total available space. By deforming the inner half-shells 17, 18, which is preferably done by folding, a continuous transition from the situation shown in FIG. 2 to this reverse situation can be achieved.

The inner half-shell 9 of the first flexible water canister 7 is thus designed such that it abuts an inner side 21 of the outer half-shell 15 of the first flexible water canister 7 when the variable volume 6 of the second compartment 4 is filled to the maximum. On the other hand, the inner half-shell 18 of the second flexible water canister 8 abuts the outer half-shell 16 of the second flexible water canister 8 when the variable volume 5 of the first compartment 3 is filled to the maximum. Accordingly, the inner half-shell 18 of the second flexible water canister 8 is designed such that it abuts an inner side 22 of the outer half-shell 16 of the second flexible water canister 8 when the variable volume 5 of the first compartment 3 is filled to the maximum. On the other hand, the inner half-shell 17 of the first flexible water canister 7 at least substantially abuts the outer half-shell 15 of the first flexible water canister 7 when the variable volume 5 of the first compartment 3 is filled to the maximum.

The first flexible water canister 7 is symmetrical in this exemplary embodiment. As a result, the inner half-shell 17 of the first flexible water canister 7 can be folded into the outer half-shell 15 of the first flexible water canister 7 during operation in such a way that the inner half-shell 17 of the first flexible water canister 7 abuts the inner side 21 of the outer half-shell 15 of the first flexible water canister 7 as closely as possible. Accordingly, the second flexible water canister 8 is symmetrical. The inner half-shell 18 of the second flexible water canister 8 can thereby be folded into the outer half-shell 16 of the second flexible water canister 8 during operation such that the inner half-shell 18 of the second flexible water canister 8 abuts the inner side 22 of the outer half-shell 16 of the second flexible water canister 8 as closely as possible. Preferably, the first water canister 7 and the second water canister 8 are designed to have the same shape specifically for this purpose.

In this exemplary embodiment, the first water canister 7 has a cubic main body 27 which comprises the outer half-shell 15 and the inner half-shell 17. In this initial example, the second water canister 8 has a cubic main body 28 which comprises the outer half-shell 16 and the inner half-shell 18. The peripheral edge 8 of the first water canister 7 and, correspondingly, also the peripheral edge 9 of the second water canister 8 lie approximately in one plane 30. In the plane 30 there are a diagonal 31 of the main body 27 of the first water canister 7 and a diagonal 32 of the main body 28 of the second water canister 8.

FIG. 4 shows the sectional view shown in FIG. 3 according to a modified embodiment in which a level probe 55, 56 is provided for measuring the level on the lower water canister 7, 8. Depending on the application, a device 55 for the first compartment 3 and/or a device 56 for the second compartment 4 can be realized. FIG. 5 shows the sectional view shown in FIG. 3 according to a modified embodiment in which a level probe 55, 56 is provided for measuring the level on the upper water canister 7, 8. FIG. 6 shows the sectional view shown in FIG. 3 according to a modified embodiment in which a level scale 55, 56 is provided for level measurement.

For this purpose, the first water canister 7 can have an outer half-shell 15 with at least one fixed wall 53 on which a device 55 for level measurement is provided. The device 55 allows measurement of the variable volume 5 of the first compartment 3. Accordingly, the second water canister 8 can have an outer half-shell 16 with at least one fixed wall 54 on which a device 56 for level measurement is provided, which allows measurement of the variable volume 6 of the second compartment 4.

FIG. 7 shows a water removal point 40 with a spacer 41, 42 in a spatial representation according to an advantageous development of a variable water tank. A water removal point 43 can also be realized corresponding to the water removal point 40. In this case, a water removal point 40, 43 can also serve as a water filling point 40, 43. For example, a spacer 41 can be provided for the first compartment 3, which ensures removal of water from the variable volume 5 of the first compartment 3. Accordingly, a spacer 42 can be provided for the second compartment 4, which ensures removal of water from the variable volume 6 of the second compartment 4. A removal hose 45 for the first compartment 3 can facilitate the removal of water from the variable volume 5 of the first compartment 3 or optionally make it possible in the first place, which can be necessary in particular when the volume 5 is almost completely emptied. Accordingly, a removal hose 46 can be provided for the second compartment 4, via which removal of water from the variable volume 6 of the second compartment 4 is simplified or made possible.

FIG. 8 shows a water tank with a water removal point 40, 43 and a spacer 41, 42 in a schematic, spatial representation to explain a modified embodiment. Other embodiments can also be realized. Preferably, the spacer 41, 42 has lateral recesses 44, one of which is marked as an example.

FIG. 9 shows different design variants for a water canister 7, 8, wherein in particular two identically shaped water canisters 7, 8 are used in a variable water tank 2. In particular, any cuboid-shaped design of the water canisters 7, 8 can be used.

FIG. 10 shows a variable water tank 2 in a spatial, partially exploded view, which is particularly suitable for an upper arrangement of the fresh water. In this case, the water removal point 40, which also serves as the water filling point 40, can be provided with a removal hose 45. Accordingly, a removal hose 46 can also be realized for the second compartment 4. The removal hose 45 may be necessary in particular for filling the service water when the volume 5 of the lower first compartment is still minimal. A similar situation arises when the fresh water is located at the bottom and fresh water is to be added. This is particularly advantageous for a variant which is permanently installed in the recreational vehicle 1.

FIG. 11 shows the variable water tank 2 shown in FIG. 10 in a schematic sectional view, wherein the lower water canister 7 can be filled with pressure. FIG. 12 shows the recreational vehicle 1 with a variable water tank 2 in a highly simplified, schematic representation.

The invention is not limited to the exemplary embodiments described.

1. Variable water tank for a recreational vehicle, in particular a motorhome or a caravan, comprising a first compartment and at least one second compartment, wherein the first compartment has a variable volume for holding water, wherein the second compartment has a variable volume for holding water and wherein the first compartment and the second compartment are separated from one another in such a way that a direct exchange of water between the first compartment and the second compartment is prevented,
characterized in that
the first compartment is at least substantially formed by a first flexible water canister, in that the second compartment is at least substantially formed by a second flexible water canister, and in that a peripheral edge of the first water canister and a peripheral edge of the second water canister are connected to one another.

2. Variable water tank according to claim 1,
characterized in that
the first flexible water canister has an outer half-shell, in that the second flexible water canister has an outer half-shell, in that the peripheral edge of the first water canister is designed as an edge of the outer half-shell of the first flexible water canister, and in that the peripheral edge of the second water canister is designed as an edge of the outer half-shell of the second flexible water canister.

3. Variable water tank according to claim 1,
characterized in that
the first flexible water canister has an inner half-shell, in that the second flexible water canister has an inner half-shell, in that the peripheral edge of the first water canister is designed as an edge of the inner half-shell of the first flexible water canister, and in that the peripheral edge of the second water canister is designed as an edge of the inner half-shell of the second flexible water canister.

4. Variable water tank according to claim 3,
characterized in that
a) the inner half-shell of the first flexible water canister is designed such that, on the one hand, it rests at least substantially against an inner side of an outer half-shell of the first flexible water canister when the variable volume of the second compartment is filled to the maximum, and, on the other hand, the inner half-shell of the second flexible water canister rests at least substantially against an outer half-shell of the second flexible water canister when the variable volume of the first compartment is filled to the maximum, and/or b) the inner half-shell of the second flexible water canister is designed such that, on the one hand, it rests at least substantially against an inner side of an outer half-shell of the second flexible water canister when the variable volume of the first compartment is filled to the maximum, and, on the other hand, the inner half-shell of the first flexible water canister rests at least substantially against an outer half-shell of the first flexible water canister when the variable volume of the first compartment is filled to the maximum.

5. Variable water tank according to claim 1,
characterized in that
a) the first flexible water canister is at least partially designed symmetrically such that an inner half-shell of the first flexible water canister can be folded into an outer half-shell of the first flexible water canister such that the inner half-shell of the first flexible water canister rests at least substantially against an inner side of the outer half-shell of the first flexible water canister, and/or
b) the second flexible water canister is at least partially designed symmetrically such that an inner half-shell of the second flexible water canister can be folded into an outer half-shell of the second flexible water canister such that the inner half-shell of the second flexible water canister rests at least substantially against an inner side of the outer half-shell of the second flexible water canister.

6. Variable water tank according to claim 1,
characterized in that
the first water canister and the second water canister are at least substantially identical in shape.

7. Variable water tank according to claim 1,
characterized in that
the first water canister has a cuboid-shaped, in particular cubic, main body which at least substantially comprises an outer half-shell of the first water canister and an inner half-shell of the first water canister, and/or in that the second water canister has a cuboid-shaped, in particular cubic, main body which at least substantially comprises an outer half-shell of the second water canister and an inner half-shell of the second water canister.

8. Variable water tank according to claim 7,
characterized in that
the peripheral edge of the first water canister or the peripheral edge of the second water canister lies at least approximately in a plane in which at least approximately at least one diagonal of the main body of the first water canister and/or at least approximately at least one diagonal of the main body of the second water canister lies.

9. Variable water tank according to claim 1,
characterized in that
a) at least one spacer is provided for the first compartment, which ensures removal of water from the variable volume of the first compartment, and/or
b) at least one spacer is provided for the second compartment, which ensures removal of water from the variable volume of the second compartment, and/or
c) at least one removal hose is provided for the first compartment, via which water can be removed from the variable volume of the first compartment, and/or
d) at least one removal hose is provided for the second compartment, via which water can be removed from the variable volume of the second compartment.

10. Variable water tank according to claim 1,
characterized in that
the first water canister has an outer half-shell with at least one fixed wall on which a device for level measurement is provided, which allows measurement of the variable volume of the first compartment, and/or in that the second water canister has an outer half-shell with at least one fixed wall on which a device for level measurement is provided, which allows measurement of the variable volume of the second compartment.

11. Recreational vehicle, in particular a motorhome or caravan, comprising at least one variable water tank which is designed according to claim 1.
